(19) United States
(12) Patent Application Publication
(10) Pub. No.: US 2013/0055182 A1
(43) Pub. Date: Feb. 28, 2013

(54) COMPUTER PRODUCT, VERIFICATION SUPPORT METHOD, AND VERIFICATION SUPPORT APPARATUS

(71) Applicant: Hiroaki IWASHITA, Tama (JP)

(72) Inventor: Hiroaki IWASHITA, Tama (JP)

(73) Assignee: FUJITSU LIMITED, Kawasaki-shi (JP)

(21) Appl. No.: 13/529,149

(22) Filed: Jun. 21, 2012

(30) Foreign Application Priority Data
Aug. 29, 2011 (JP) 2011-186546

(51) Int. Cl. G06F 9/455

(52) U.S. Cl. 716/108

(57) ABSTRACT

A computer-readable medium stores a verification support program that causes a computer to execute a process that includes executing a first simulation of applying a given input pattern to circuit information of a circuit under test having a first clock domain and a second clock domain that receives asynchronously a signal from the first clock domain; detecting during execution of the first simulation, an output value that is a random value output by an element in the second clock domain; copying the execution state of the first simulation at the time of detection of the output value; setting in the copied execution state of the first simulation, output of the element in the second clock domain, to a logic value that is different from the detected output value; and executing, exclusive of the first simulation, a second simulation that is based on the set execution state.

### CROSS REFERENCE TO RELATED APPLICATIONS

This application is based upon and claims the benefit of priority of the prior Japanese Patent Application No. 2011-186546, filed on Aug. 29, 2011, the entire contents of which are incorporated herein by reference.

### FIELD

The embodiments discussed herein are related to verification of circuit information for semiconductor integrated circuits.

### BACKGROUND

Conventionally, in semiconductor integrated circuits, multiple clocks of different frequencies are used in a single semiconductor integrated circuit consequent to complicated functions and power conservation. When circuit blocks within a semiconductor integrated circuit are divided based on clock sources, the resulting regions are called clock domains, between which the handing over of signals (clock domain crossing (CDC)) may be performed.

For each flip flop (FF), a setup time and a hold time are defined and when the setup time and/or hold time is violated, a metastable state occurs. A metastable state is when output is in an unstable state, a state where it is unclear whether 0 or 1 is to be output. By CDC, when signals are handed over asynchronously, the occurrence of a metastable state cannot be avoided due to a violation of a setup time and/or hold time.

The effects of a metastable state are propagated as a logic value disparity, to a downstream FF, combinational circuit, etc., arising in errant operation of the semiconductor integrate circuit. Consequently, even if a metastable state occurs, it has to be verified that the semiconductor integrated circuit does not operate errantly. However, in logic verification using a typical FF model, the effect of the metastable state is not considered.

Thus, CDC simulation of simulating the randomness of signals received from different clock domains is performed as a means of performing verification related to the mechanism of handing over signals at CDCs.

A related technology, for example, extracts a location that is asynchronous and generates a verification-use vector. Further, for example, a technology builds on a field programmable gate array (FPGA) a metastable state generating circuit that generates a pseudo metastable state signal. A further technology, for example, compares simulation results and expected values, and when the former and the latter do not coincide, suspends simulation. For example, refer to Japanese Laid-Open Patent Publication Nos. 2009-59024, 2009-9318, and 2005-182093.

A typical logic simulation is performed and if it is verified that no errors in the function of the semiconductor integrated circuit occur, a CDC simulation is performed. Thus, a location causing an error in the CDC simulation is a CDC location. A CDC location is the location where data is handed over from an FF in a first clock domain to an FF in a second clock domain. Since multiple FFs and combinational circuits are passed from the location causing the error until location when the occurrence of the error is determined, the distance therebetween is great and it takes time for the determination to be output. The location when the occurrence of an error is determined is, for example, the output terminal of a circuit under test.

To cover all of combinations of CDC jitter, simulations equivalent to 2̂CDC jitter count (where, “̂” indicates an exponent) have to be executed, which is time consuming.

### SUMMARY

According to an aspect of an embodiment, a computer-readable medium stores therein a verification support program that causes a computer to execute a process. The process includes executing a first simulation of applying a given input pattern to circuit information of a circuit under test having a first clock domain and a second clock domain that receives asynchronously a signal from the first clock domain; detecting during execution of the first simulation, an output value that is a random value output by an element in the second clock domain that receives the signal; copying the execution state of the first simulation at the time of detection of the output value that is a random value; setting in the copied execution state of the first simulation, output of the element in the second clock domain, to a logic value that is different from the detected output value; and executing, exclusive of the first simulation, a second simulation that is based on the set execution state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting an example of simulation according to embodiments.

FIG. 2 is a diagram depicting an example of CDC.

FIG. 3 is a diagram depicting an example of the results of a simulation using a typical FF model.

FIG. 4 is a diagram depicting an example of the results of simulation using a CDC model.

FIG. 5 is a flowchart depicting the flow of CDC verification.

FIG. 6 is a diagram depicting an example of an observation point for the propagation of the effects of CDC jitter.

FIG. 7 is a block diagram depicting an example of a hardware configuration of a verification support apparatus.

FIG. 8 is a diagram depicting an example of a simulation model.

FIG. 9 is a diagram depicting an example of a second clock domain in a circuit under test model 822.

FIG. 10 is a diagram depicting an example of a CDC model depicted in FIG. 9.

FIG. 11 is a diagram depicting an example of a jitter detector.

FIG. 12 is a diagram depicting an example of an input pattern and expected values.

FIG. 13 is a block diagram depicting an example of a functional configuration of a verification support apparatus 700 according to a first embodiment.

FIG. 14 is a diagram depicting an example of simulation according to the first embodiment.

FIG. 15 is a flowchart depicting processing performed by a parent process 1300 of the verification support apparatus 700 according to the first embodiment.

FIG. 16 is a flowchart depicting processing performed by a child process 1320-i of the verification support apparatus 700 according to the first embodiment.

FIG. 17 is a diagram depicting an example of reducing the number of simulation invocations according to a second embodiment.

FIG. 18 is a block diagram depicting an example of a functional configuration of the verification support apparatus 700 according to the second embodiment.

FIG. 19 is a diagram depicting an example of simulation according to the second embodiment.

FIG. 20 and FIG. 21 are flowcharts depicting processing performed by a parent process 1800 of the verification support apparatus 700 according to the second embodiment.

FIG. 22 is a flowchart depicting the processing performed by a child process 1820 that is of the verification support apparatus 700 according to the second embodiment and executes a fundamental execution pattern.

FIG. 23 and FIG. 24 are flowcharts depicting processing performed by a child process 1830-j that is of the verification support apparatus 700 according to the second embodiment and executes an inverted pattern.

FIG. 25 is a diagram depicting an example of the time required for simulation.

### DESCRIPTION OF EMBODIMENTS

Preferred embodiments of the present invention will be explained with reference to the accompanying drawings. In the present embodiments, one example of a method of improving verification efficiency with respect to logic design that includes CDCs will be described.

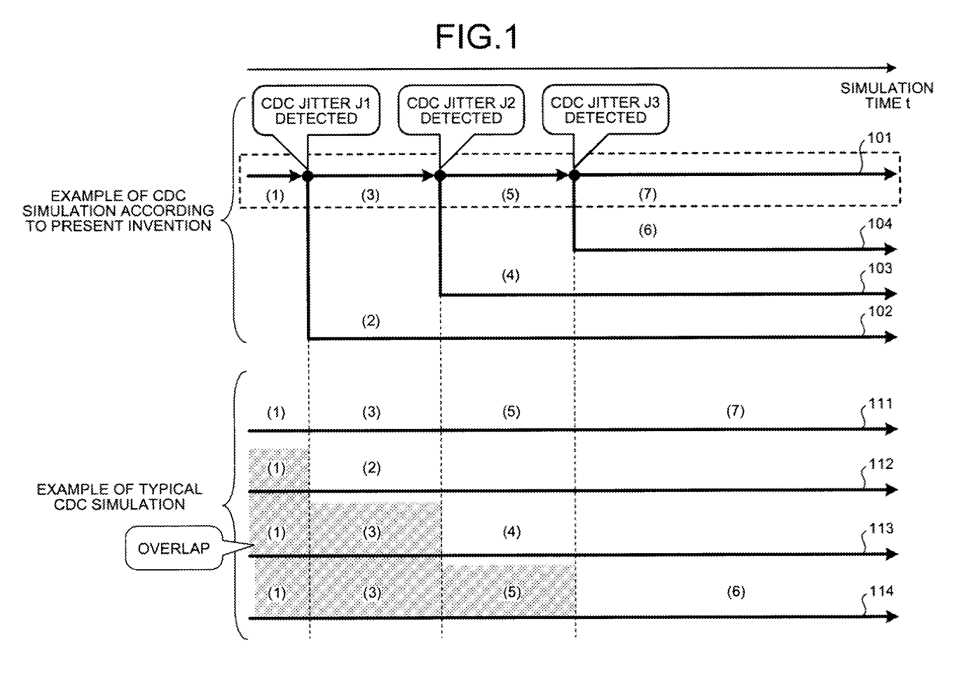

FIG. 1 is a diagram depicting an example of simulation according to the embodiments. Although dependent on circuit information of and input patterns to a circuit under test, CDC jitter occurs in the several hundreds to several ten-thousands. As described above, in order to cover all combinations of CDC jitter, simulations equivalent to 2̂total CDC jitter count have to be executed, which is time consuming. As depicted in the example in FIG. 1, in the case of a CDC jitter count of 3, J1-J3, the combinations of the logic values of J1-J3 include 8 types, (J1,J2,J3)=(0,0,0) to (1,1,1), and therefore, 8 simulations have to be executed.

Thus, by omitting overlapping executions of a given simulation by providing a given input pattern to circuit information via a logic simulator and another simulation where among the CDC jitter occurring in the given simulation, the logic value of 1 CDC jitter differs, the simulation time can be shortened.

In the example depicted in FIG. 1, when 3 CDC jitters occur, a verification support apparatus according to the embodiments sequentially selects each of the 3 CDC jitters and identifies whether the effect of the CDC jitter is propagated. In a typical CDC simulation, 4 simulations have to be performed. Since multiple simulations cannot be performed simultaneously by a logic simulator, the time consumed is equivalent to the time consumed for 4 simulations.

In the embodiments, since overlapping simulations are not performed, the simulation time is shortened. The verification support apparatus detects CDC jitter J1 during execution of (1) in simulation 101 in which a given input pattern is applied to the circuit information of a circuit under test.

The verification support apparatus copies the execution state of simulation 101 when CDC jitter J1 was detected. The verification support apparatus sets the output of an element within a second clock domain in the copied execution state of simulation 101, to a logic value that is different from the detected output value. The verification support apparatus executes, exclusive of simulation 101, simulation 102 (second simulation) that is based on the set execution state. Since a logic simulator cannot execute multiple simulations in parallel, during the execution of a simulation, the execution of another is on stand-by.

The verification support apparatus detects CDC jitter J2 during the execution of (3) in simulation 101. The verification support apparatus copies the execution state of simulation 101 when CDC jitter J2 was detected. The verification support apparatus sets the output of an element within the second domain in the copied execution state of simulation 101, to a logic value that is different from the detected value. The verification support apparatus executes, exclusive of simulation 101, simulation 103 (second simulation) that is based on the set execution state. In the example depicted in FIG. 1, simulation 103 is performed, followed by simulation 101.

The verification support apparatus detects CDC jitter J3 during execution of (5) in simulation 101. The verification support apparatus copies the execution state of simulation 101 when CDC jitter J3 was detected. The verification support apparatus sets the output of an element in the second clock domain in the copied execution state of simulation 101, to a logic value that is different from the detected value. The verification support apparatus executes, exclusive of simulation 101, simulation 104 (second simulation) that is based on the set execution state. In the example depicted in FIG. 1, the verification support apparatus performs simulation 104, followed by simulation 101.

In the CDC simulation example depicted in FIG. 1, compared to a typical CDC simulation (simulations 111-114), the simulation time is reduced by the simulation time of (1)×3, the simulation time of (3)×2, and the simulation time of (5).

For the sake of easy understanding, CDC and CDC simulation will be described further prior to detailed description of the embodiments.

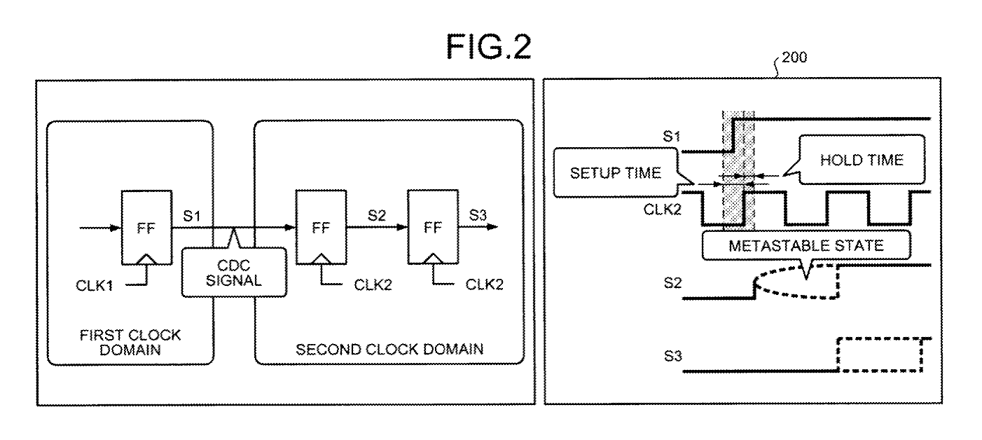

FIG. 2 is a diagram depicting an example of CDC. In FIG. 2, signal S1, which is a signal output from an FF in the first clock domain, is a signal input to an FF in the second clock domain. The FF in the first clock domain operates synchronized with CLK1 and the FF in the second clock domain operates synchronized with CLK2. When data from the FF in the first clock domain is handed over to the FF in the second clock domain, the data is input irrespective of the clock timing of the FF in the second clock domain.

For each FF, a setup time and a hold time are defined. If the setup time and/or the hold time is violated, a metastable state occurs. A metastable state is an unstable state, a state where it is unclear whether 0 or 1 is to be output. As depicted in timing chart 200, signal S1, which is the output of an FF in the first clock domain, may violate the setup time or the hold time of an FF in the second clock domain if signal S1 changes near the rising edge of CLK2. Consequent to such a violation, signal S2, which is the output of an FF in the second clock domain may enter a metastable state.

The effect of a metastable state may be propagated, as logic value disparity, to downstream FFs and combinational circuits, causing errant operation of the semiconductor integrated circuit. Thus, it must be verified that even if a metastable state occurs, the semiconductor integrated circuit does not operate errantly. Herein, logic simulation using a typical FF model will be described.

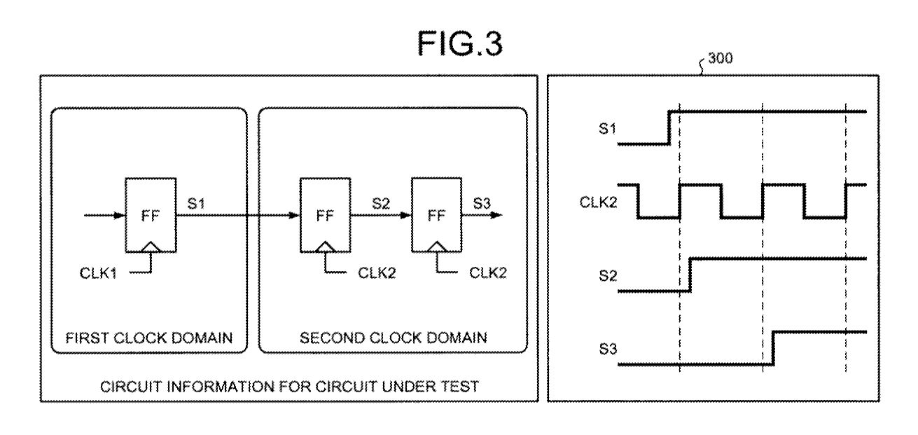

FIG. 3 is a diagram depicting an example of the results of a simulation using a typical FF model. As depicted by timing chart 300, in a simulation using a typical FF model, even if the change of signal S1 occurs near the rising edge of CLK2, the value of signal S1 at the time of the rising edge of CLK2 outputs signal S2. In other words, even if the setup time or the hold time is violated, the effect of this violation cannot be simulated.

Thus, the model of the FF that is in the second clock domain and receives (out of synch with CLK2) a signal from an FF in the first clock domain is changed to a model (CDC model) that simulates the effect of the metastable state. Herein, CDC simulation using a CDC model will be described.

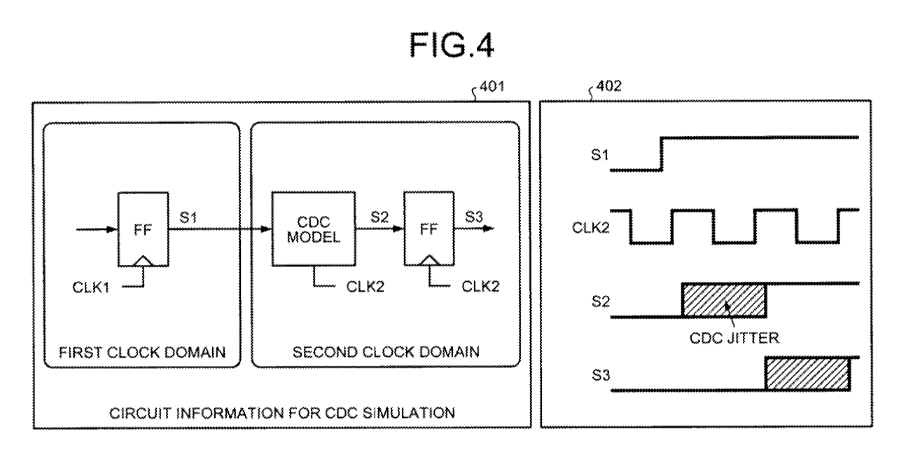

FIG. 4 is a diagram depicting an example of the results of simulation using a CDC model. In circuit information 401, the FF that receives signal S1 from the first clock domain is changed to a CDC model. As depicted in timing chart 402, if the change of signal S1 occurs near the rising edge of CLK2, at the rising edge of CLK2, signal S2 is output as a random value of 0 or 1 during 1 clock cycle period. Herein, the random value during 1 clock cycle period is called CDC jitter.

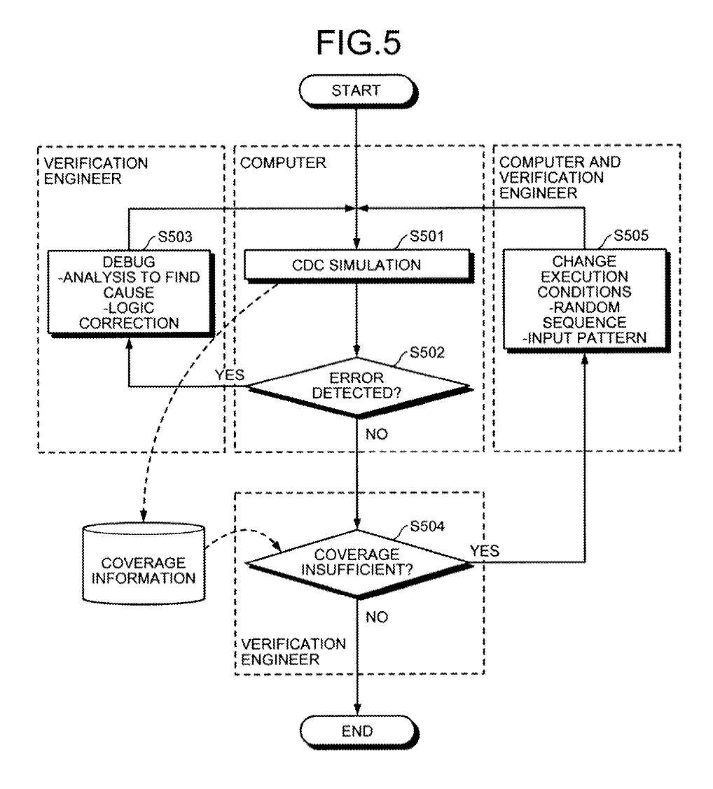

FIG. 5 is a flowchart depicting the flow of CDC verification. A computer having a logic simulator and capable of logic simulation applies a given input pattern to the circuit information of a circuit under test and executes CDC simulation (step S501). The computer determines whether a logic error (error) has been detected (step S502).

If the computer determines that an error has been detected (step S502: YES), the verification engineer performs manual debugging (step S503), and the flow returns to step S501, whereby the computer uses the debugged circuit information and executes CDC simulation. The debugging is, for example, analysis to determine the cause of the logic error (cause of error) and/or for logic correction.

If the computer determines that no error has been detected (step S502: NO), the verification engineer uses coverage information and determines whether coverage is insufficient (step S504). If the verification engineer determines that coverage is insufficient (step S504: YES), the verification engineer changes an execution condition (step S505), and the flow returns to step S501. Here, a change of an execution condition is, for example, a change of a random sequence or a change of the input pattern. If the verification engineer determines that coverage is sufficient (step S504: NO), the verification engineer ends the CDC verification.

In CDC simulation, since the effect of a metastable state is included in the simulation results, analysis of the cause of failure (cause of error) is difficult. Therefore, the verification engineer confirms that no problems exist with normal functions, via typical logic simulation, before the switch to a CDC model. Thereafter, the verification engineer uses the same input pattern used for the typical logic simulation, performs CDC simulation, and checks for problems caused by the effects of a metastable state.

As criteria for judging CDC coverage, the verification engineer uses execution results of a typical CDC simulation and determines coverage to be insufficient according to whether the effect of CDC jitter is observed up to an observation point. For example, the observation point may be an output terminal, the output of an FF representing the state of the circuit under test, the output of an element downstream from the CDC model, etc. Further, for example, the observation point may be a location where multiple CDC signals are handed over from the first clock domain to the second clock domain, or may be an assertion. An assertion is a location having a property that has been defined by the design of the circuit under test and that must be satisfied.

As described, to cover all combinations of CDC jitter, a problem arises in that simulations equivalent to 2̂CDC jitter count (where, “̂” indicates an exponent) have to be executed, which is time consuming. If all combinations of CDC jitter are not simulated, the verification engineer simulates only CDC jitter combinations arbitrarily selected while performing manual debugging, arising in a problem that analysis to find the cause of the error is time consuming.

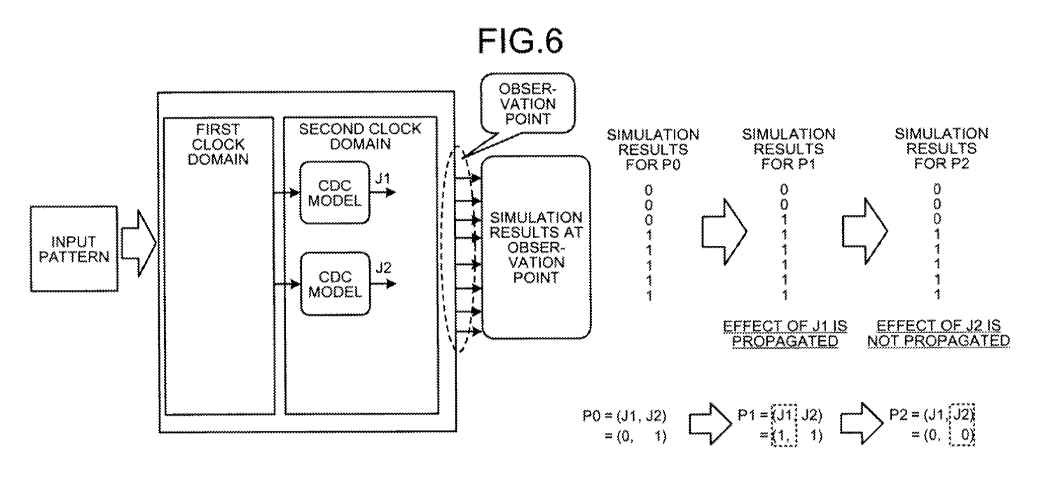

FIG. 6 is a diagram depicting an example of an observation point for the propagation of the effects of CDC jitter. FIG. 6 depicts an example where the verification support apparatus verifies whether the effect of each CDC jitter is propagated to the observation point, in order to facilitate the analysis performed by the verification engineer to find the cause of error.

As depicted in FIG. 6, the verification support apparatus sets the output value of a given CDC jitter to a logic value that is different from the logic value of the CDC jitter resulting from CDC simulation of a given input pattern. The verification support apparatus, based on the simulation results and the simulation results after the setting, identifies whether for the given input pattern, the effect of each CDC jitter is propagated to the observation point.

In FIG. 6, when the verification support apparatus provides an input pattern to a test bench, CDC jitters J1, J2 arise from CDC models in the second clock domain. Four execution patterns can be derived by combining the logic values of CDC jitters J1, J2. Execution pattern combinations are indicated by P=(J1, J2). Execution pattern PO depicted in FIG. 6 is (J1, J2)=(0, 1). The verification support apparatus simulates execution pattern P1=(J1, J2)=(1, 1) in which a logic value that is different from the logic value of CDC jitter J1 (0) in execution pattern P0 is set. In FIG. 6, since the simulation result for execution pattern P0 at the observation point and the simulation result for execution pattern P1 at the observation point differ, the verification support apparatus determines that the effect of CDC jitter J1 is propagated to the observation point.

The verification support apparatus simulates execution pattern P2=(J1, J2)=(0, 0) in which a logic value different from the logic value of CDC jitter J2 in execution pattern P0 is set. In FIG. 6, since the simulation result for execution pattern P0 at the observation point and the simulation result for execution pattern P2 at the observation point differ, the verification support apparatus determines that the effect of CDC jitter J2 is propagated to the observation point.

Therefore, although there are 4 combinations of CDC jitter J1, J2, by verifying 3 combinations, the verification support apparatus can determine which CDC jitter exerts an effect that is propagated. From the propagation of an effect, the verification engineer can determine which CDC jitter exerts an effect related to an error. Consequently, the verification support apparatus can reduce the number of simulations and facilitate the identification of the source of an error consequent to CDC jitter.

In first and second embodiments, the simulation time is shortened by omitting overlapping simulations where among multiple CDC jitters such as those depicted in FIG. 6, the logic value of only 1 CDC jitter differs. An example of a hardware configuration of the verification support apparatus in the first and the second embodiments, and a simulation model used in the first and the second embodiments will be described.

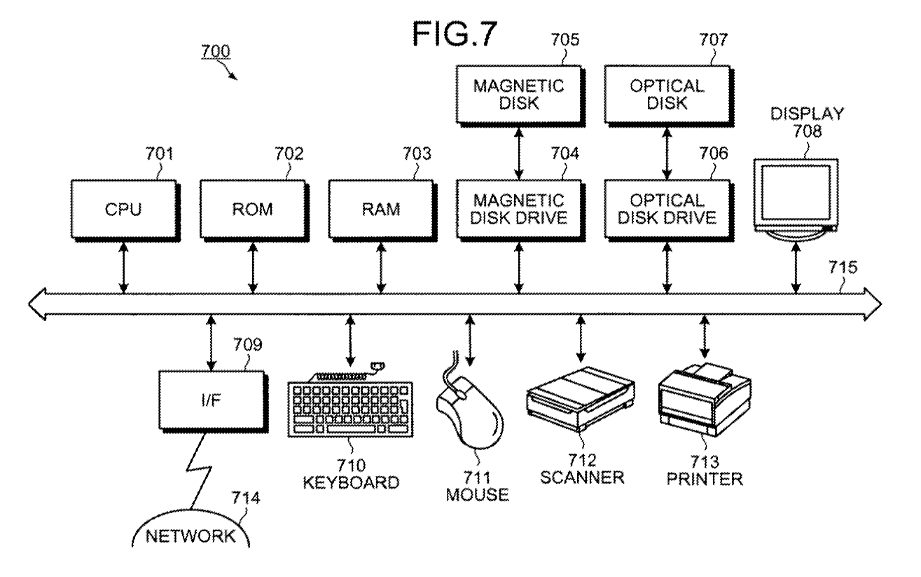

FIG. 7 is a block diagram depicting an example of a hardware configuration of the verification support apparatus. As depicted in FIG. 7, a verification support apparatus 700 includes a central processing unit (CPU) 701, a read-only memory (ROM) 702, a random access memory (RAM) 703, a magnetic disk drive 704, a magnetic disk 705, an optical disk drive 706, an optical disk 707, a display 708, an interface (I/F) 709, a keyboard 710, a mouse 711, a scanner 712, and a printer 713, respectively connected by a bus 715.

The CPU 701 governs overall control of the verification support apparatus 700. The ROM 702 stores therein programs such as a boot program. The RAM 703 is used as a work area of the CPU 701. The magnetic disk drive 704, under the control of the CPU 701, controls the reading and writing of data with respect to the magnetic disk 705. The magnetic disk 705 stores therein data written under control of the magnetic disk drive 704.

The optical disk drive 706, under the control of the CPU 701, controls the reading and writing of data with respect to the optical disk 707. The optical disk 707 stores therein data written under control of the optical disk drive 706, the data being read by a computer.

The display 708 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 708.

The I/F 709 is connected to a network 714 such as a local area network (LAN), a wide area network (WAN), and the Internet through a communication line and is connected to other apparatuses through the network 714. The I/F 709 administers an internal interface with the network 714 and controls the input/output of data from/to external apparatuses. For example, a modem or a LAN adaptor may be employed as the I/F 709.

The keyboard 710 includes, for example, keys for inputting letters, numerals, and various instructions and performs the input of data. Alternatively, a touch-panel-type input pad or numeric keypad, etc. may be adopted. The mouse 711 is used to move the cursor, select a region, or move and change the size of windows. A track ball or a joy stick may be adopted provided each respectively has a function similar to a pointing device.

The scanner 712 optically reads an image and takes in the image data into the verification support apparatus 700. The scanner 712 may have an optical character reader (OCR) function as well. The printer 713 prints image data and text data. The printer 713 may be, for example, a laser printer or an ink jet printer.

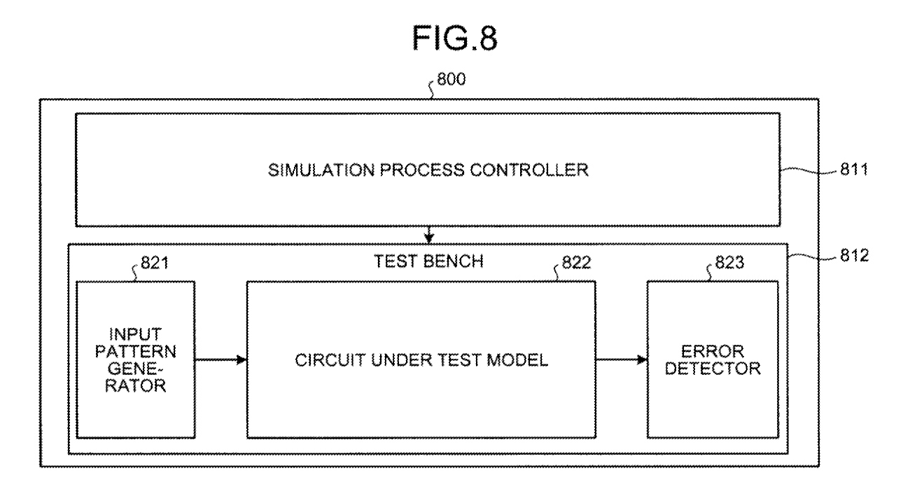

FIG. 8 is a diagram depicting an example of the simulation model. A simulation model 800 includes a test bench 812 and a simulation process controller 811. The simulation model 800, for example, is described in a hardware description language (HDL) such as Verilog-HDL and System-Verilog. The simulation model 800 is stored to a storage device such as the RAM 703, the magnetic disk 705, and the optical disk 707.

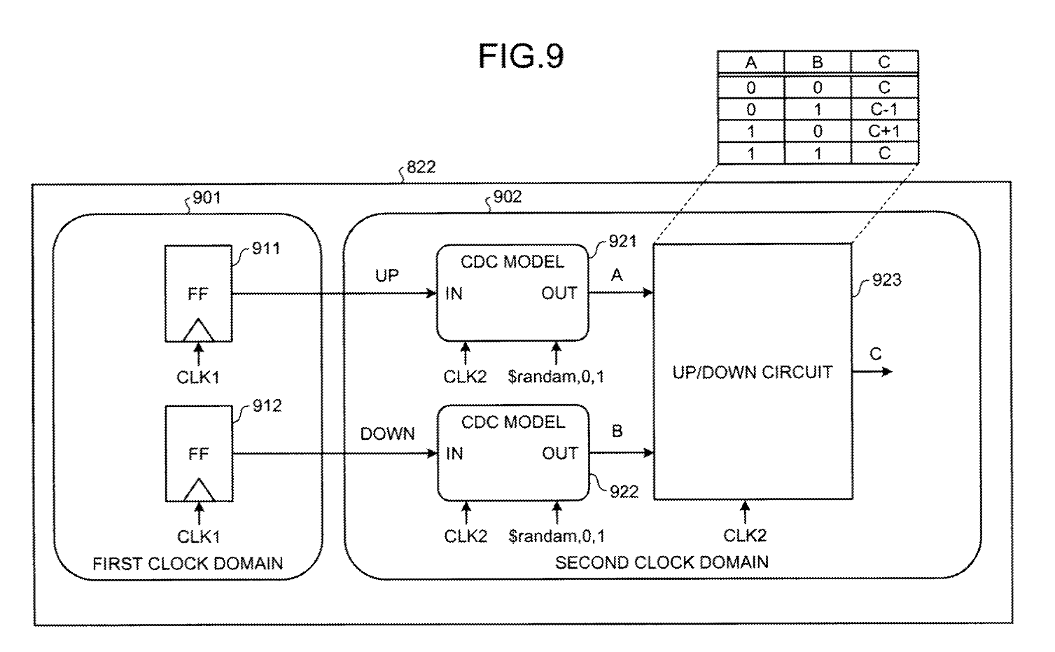

The simulation process controller 811 is a model that controls the test bench 812. Details of the simulation process controller 811 will be described hereinafter. The test bench 812 includes a circuit under test model 822, an input pattern generator 821, and an error detector 823. When simulation of the test bench 812 is started by the logic simulator, the input pattern generator 821 generates an input pattern. The input pattern is provided to the circuit under test model 822 by the logic simulator and the circuit under test model 822 is simulated according to the input pattern. The signal from the circuit under test model 822 and used in verification is output as a simulation result. The error detector 823 compares the simulation result and expected values to thereby detect an error. The circuit under test model 822 is the circuit information of the circuit under test and a detailed example of the circuit under test model 822 used in the embodiments is depicted in FIG. 9.

FIG. 9 is a diagram depicting an example of the second clock domain in the circuit under test model 822. As depicted in FIG. 9, the circuit under test model 822 has a first clock domain 901 and a second clock domain 902. The second clock domain 902 has a CDC model 921, a CDC model 922, and an up/down circuit 923. Signal UP from an FF 911 in the first clock domain 901 is input to the CDC model 921. Signal DOWN from an FF 912 in the first clock domain 901 is input to the CDC model 922.

For example, the up/down circuit 923 is an up/down counter. For instance, at the up/down circuit 923, when signal UP becomes high, signal A becomes high and consequently, the value of signal C is incremented; and when signal DOWN becomes high, signal B becomes high and consequently, the value of signal C is decremented. Here, it is assumed that signal UP and signal DOWN are not high simultaneously.

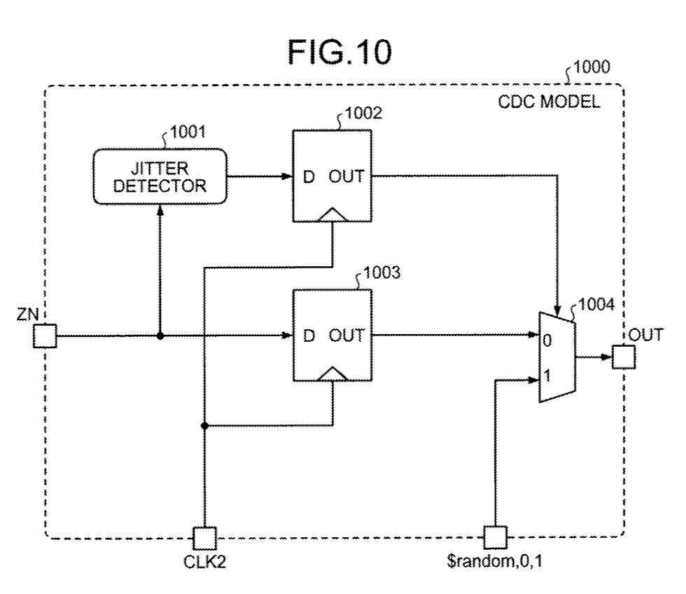

FIG. 10 is a diagram depicting an example of the CDC model depicted in FIG. 9. A CDC model 1000 depicted in FIG. 10 includes description for an operation that detects a change of the input signal and when a clock event occurs within a given period since the time of detection of the change, outputs a random value during the interval of the clock event. The CDC model 1000 includes a jitter detector 1001, an FF 1002, an FF 1003, and a selector circuit 1004.

The jitter detector 1001 detects a change in the value of the input signal and outputs 1 before a given period elapses since the time of detection of the change. The FF 1002 takes in the output of the jitter detector 1001 at the rising edge of CLK2. The selector circuit 1004 outputs the output signal of the FF 1003 if the output signal of the FF 1002 is 0 and outputs a value input from an external device if the output signal of the FF 1002 is 1.

Here, a value input from an external device is, for example, a random value, 0, or 1. In a typical CDC model, only a random value is input, however, in the embodiments, any one among a random number, 0, and 1 are input by the simulation process controller 811 or the test bench 812. Consequently, the verification support apparatus 700 can set a logic value that is different from the logic value output by the CDC model 921 and/or the CDC model 922 depicted in FIG. 9.

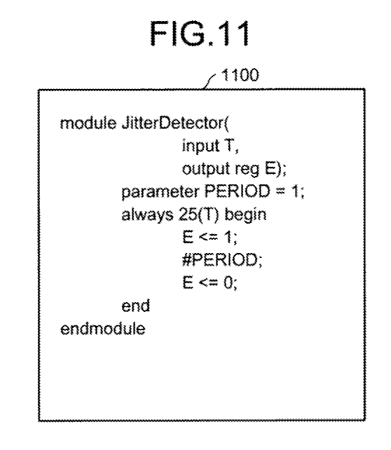

The CDC model 1000, for example, is stored as a library, to a storage device such as the RAM 703, the magnetic disk 705, and the optical disk 707. The CDC model stored in the library is specified by the circuit under test model 822. The logic simulator reads out the CDC model from the library and executes the processing described by the CDC model. Next, with reference to FIG. 11, a detailed example of the jitter detector 1001 will be described.

FIG. 11 is a diagram depicting an example of the jitter detector. At a jitter detector 1100, the input signal is “T” and the output signal is “E”. At the jitter detector 1100, when the value of T changes from 0 to 1 or from 1 to 0, the value of E is 1 until a period equivalent to PERIOD elapses.

The jitter detector 1100, for example, is stored as a library, to a storage device such as the RAM 703, the magnetic disk 705, and the optical disk 707. The jitter detector 1100 stored in the library is specified by the CDC model 1000. The logic simulator reads out from the library, the processing described for the jitter detector 1100 and executes the processing.

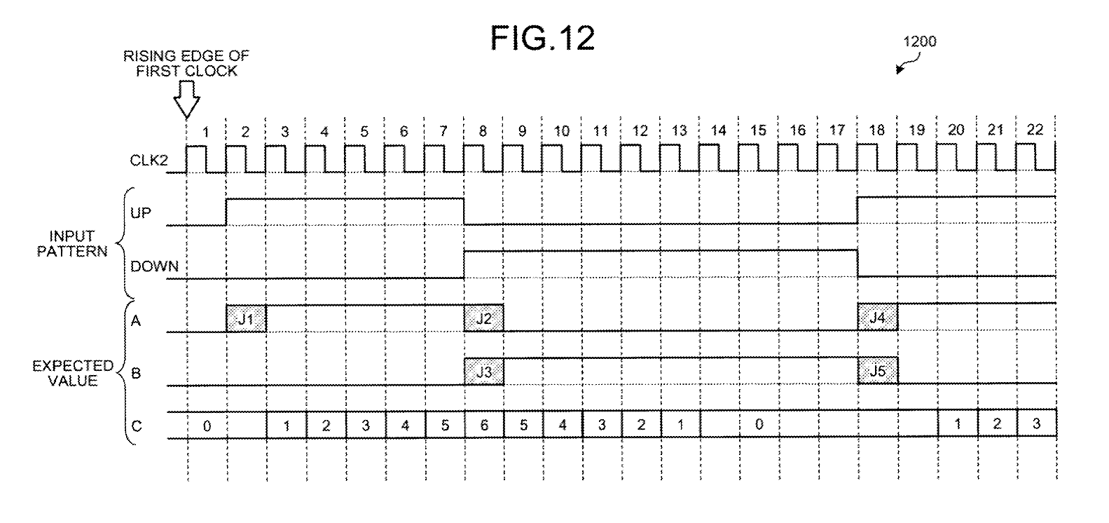

FIG. 12 is a diagram depicting an example of an input pattern and expected values. In timing chart 1200 in FIG. 12, 1 cycle is from the rising edge of CLK2 to just before the next rising edge and for the sake of easy understanding, the cycles (clocks) are numbered sequentially above CLK2. For example, the rising edge of the first clock is indicated by the arrow in the diagram.

In the input pattern, signal UP violates the setup time or the hold time at the rising edge of the second clock and consequently, among the expected values, signal A is subject to CDC jitter J1. In the input pattern, signal UP and signal DOWN violate the setup time or the hold time at the rising edge of the eighth clock and consequently, among the expected values, signal A is subject to CDC jitter J2 and signal B is subject to CDC jitter J3.

In the input pattern, signal UP and signal DOWN violate the setup time or the hold time at the eighteenth clock and consequently, among the expected values, signal A is subject to CDC jitter J4 and signal B is subject to CDC jitter J5. In the first embodiment, description will be given using CDC jitters J1-J3 and in the second embodiment, description will be given using CDC jitters J1-J5.

In the first embodiment, to reduce overlapping simulation, simulation is performed where during simulation of a base execution pattern, CDC jitter is detected and whether the effect of the detected CDC jitter is propagated is confirmed, thereby enabling the simulation time to be reduced.

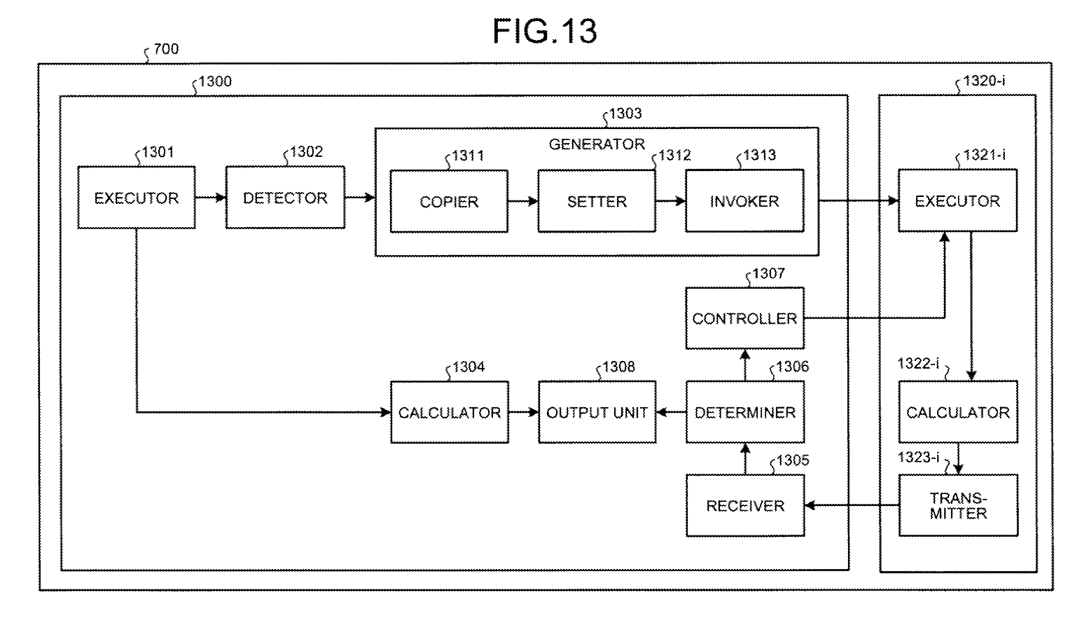

FIG. 13 is a block diagram depicting an example of a functional configuration of the verification support apparatus 700 according to the first embodiment. The verification support apparatus 700 includes a parent process 1300 and child processes 1320-i (i=1 to total number of CDC jitters). The parent process 1300 executes a first simulation related to a base execution pattern and generates 1 or more child processes 1320-i. The child process 1320-i executes a second simulation related to an inverted execution pattern having among multiple CDC jitters, a logical value of 1 CDC jitter, different from the logic values for the base execution pattern.

The parent process 1300 has an executor 1301, a detector 1302, a generator 1303, a calculator 1304, a receiver 1305, a determiner 1306, a controller 1307, and an output unit 1308. The child process 1320-i has an executor 1321-i, a calculator 1322-i, and a transmitter 1323-i.

Processes of the executor 1301 to the output unit 1308 of the parent process 1300, for example, are encoded by the simulation process controller 811 of the simulation model 800 above. Processes of the executor 1321-i and the transmitter 1323-i of the child process 1320-i, for example, are encoded by the simulation process controller 811 of the simulation model 800. The CPU 701 invokes the logic simulator and provides the simulation model 800 to the logic simulator, whereby the logic simulator processes the code described by the simulation process controller 811 of the simulation model 800.

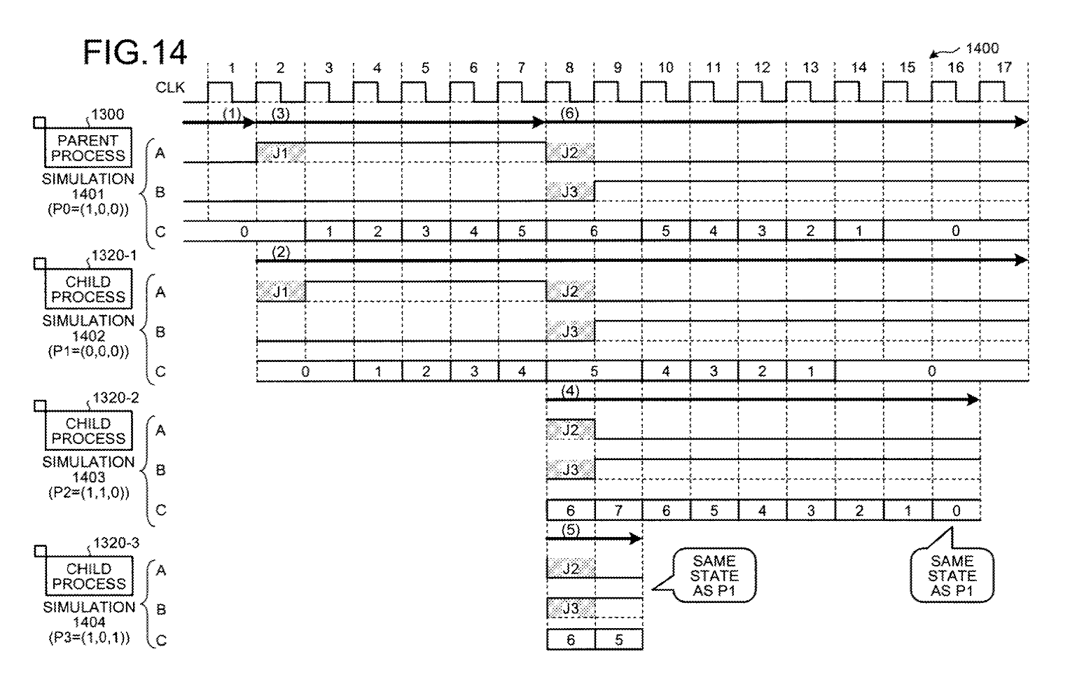

FIG. 14 is a diagram depicting an example of simulation according to the first embodiment. In timing chart 1400 in FIG. 14, (1) to (5) are sequentially executed. In the example depicted in FIG. 14, up to the seventeenth clock is depicted of the input pattern above and therefore, the total CDC jitter count is 3, and i is 1 to 3. For example, the executor 1301 executes simulation 1401 for which the input pattern has been provided. For instance, in simulation 1401, it is assumed that execution pattern P0=(J1, J2, J3)=(1, 0, 0). For execution pattern P0, random values may be generated by CDC jitter or the verification engineer may specify values in advance.

For example, the calculator 1304, for each given period during the execution of simulation 1401, calculates hash values related to the state of a given element and to the state of an observation point. The given period, for example, may be an execution unit defined in the simulation model 800. An FF can be given as an example of a given element. In the circuit under test model 822, the given element is the CDC model 921, the CDC model 922, and the up/down circuit 923. Use of the hash values enables faster searches. The hash values may be calculated based on a known technique (e.g., HOLZMANN, GERARD J., “An Improved Protocol Reachability Analysis Technique”, Bell Laboratories; or Wolper, Pierre, et al, “Reliable Hashing without Collision Detection”, Computer Aided Verification, Proc, Int. Workshop, Elounda, Crete, Lecture Notes in Computer Science, Vol. 697, Springer Verlag, June 1993). The output unit 1308 correlates and outputs execution pattern P1 and a combination of the simulation time and the calculated hash value related to the state of a given element. The form of output may be, for example, transmission to an external apparatus via the I/F 709, and storage to a storage device such as the RAM 703, the magnetic disk 705, and the optical disk 707.

For example, during execution of simulation 1401 by the executor 1301, the detector 1302 detects CDC jitter. For instance, the detector 1302 may determine whether random values occur during the execution of simulation 1401 to thereby detect CDC jitter. Alternatively, for example, the detector 1302 may monitor whether the value a selection signal input by the selector circuit 1004 in the CDC model 1000 depicted in FIG. 10 is 1. If execution pattern PO is preliminarily specified by the verification engineer and the parent process 1300 knows the timing at which CDC jitter occurs, the detector 1302 may detect CDC jitter according to which clock the current clock is. For example, the detector 1302 detects CDC jitter J1 at the rising edge of the second clock.

Subsequently, the generator 1303 generates the child process 1320-1, which executes simulation 1402 that for the output value of the element that output CDC jitter J1 detected by the detector 1302, has an logic value that is different from the logic value detected by the detector 1302. The generator 1303, for example, has a copier 1311, a setter 1312, and an invoker 1313.

For example, the copier 1311 copies the execution state of simulation 1401 at the time of detection by the detector 1302. The execution state, for example, is an image of the memory. An image of the memory is, for example, information related to simulation 1401 established in the RAM 703, code of the simulation model 800, the value of signals in the circuit under test model 822, etc.

The setter 1312, for example, in the execution state copied by the copier 1311, sets the output value of the element that output CDC jitter J1 detected by the detector 1302, to a logic value that is different from the logic value detected by the detector 1302. Thus, in simulation 1402, execution pattern P1=(J1, J2, J3)=(0, 0, 0), and the invoker 1313 specifies the execution state set by the setter 1312 to be the execution conditions of the child process 1320-1 and invokes the child process 1320-1.

When the child process 1320-1 is generated by the generator 1303, the executor 1321-1 of the child process 1320-1, based on the set execution state, executes simulation 1402 exclusive of simulation 1401. Since the logic simulator cannot execute 2 simulations simultaneously, simulation 1401 and simulation 1402 are executed exclusively. In the example depicted in FIG. 14, after CDC jitter J1 occurs in simulation 1401, simulation 1402 is executed before the rest of simulation 1401 is executed.

The calculator 1322-1, for example, for each given period, calculates hash values related to the state of a given element and the state of an observation point. At each given period, the transmitter 1323-1 transmits a combination of the simulation time and the calculated hash values to the parent process 1300.

The receiver 1305, for example, receives the combination of the simulation time and hash values from the child process 1320-1. The determiner 1306 determines whether the combination received by the receiver 1305 is among the combinations correlated to execution pattern PO and stored to a storage device by the output unit 1308.

Here, since simulation 1402 is executed before the rest of simulation 1401 after the occurrence of CDC jitter J1, the state of the given element in simulation 1401 is unknown. Therefore, for example, the output unit 1308 correlates and outputs execution pattern P1 and a combination of the simulation time and hash values. The form of output is, for example, storage to a storage device such as the RAM 703, the magnetic disk 705, and the optical disk 707.

When the child process 1320-1 ends consequent to completion of simulation 1402, the executor 1301 executes the rest of simulation 1401 after the occurrence of CDC jitter J1 and for example, the detector 1302 detects CDC jitter J2 and CDC jitter J3 at the rising edge of the eighth clock.

In this case, the generator 1303 generates the child process 1320-2, which executes simulation 1403 that for the output value of the element that output CDC jitter J2 detected by the detector 1302, has a logic value that is different from the logic value detected by the detector 1302. The generation processing performed by the generator 1303 to generate the child process 1320-2 that executes simulation 1403 is the same processing as the generation processing for generating the child process 1320-1 that executes simulation 1402 and description thereof is omitted. Thus, in simulation 1403, execution pattern P2=(J1, J2, J3)=(1, 1, 0).

The executor 1321-2 executes simulation 1403, based on the set execution state. The calculator 1322-2, for each given period, calculates hash values related to the sate of a given element and the state of an observation point. The transmitter 1323-2 transmits a combination of the simulation time and the hash values calculated by the calculator 1322-2 to the parent process 1300.

The receiver 1305 receives the combination of the simulation time and the hash values from the child process 1320-2. The determiner 1306 determines whether the combination received by the receiver 1305 is among the combinations correlated to execution patterns P1, P2 and output by the output unit 1308.

In FIG. 14, for example, signals A, B, C of simulation 1403 by the child process 1320-2 at the sixteenth clock are identical to signals A, B, C of simulation 1402 by the child process 1320-1. Therefore, the determiner 1306 determines that a combination identical to the combination received by the receiver 1305 is present.

The controller 1307, when the determiner 1306 determines that a combination identical to the received combination is present, forcibly terminates the child process 1320-2. In other words, the rest of simulation 1403 (by the child process 1320-2) from the seventeenth clock is identical to simulation 1402 by the child process 1320-1 and therefore need not be executed. Thus, consequent to the controller 1307 forcibly terminating the child process 1320-2, the simulation time can be shortened.

Similar to the generation of the child processes 1320-1, 1320-2 related to CDC jitters J1, J2, the generator 1303 generates the child process 1320-3, which executes simulation 1404 that is an inverted pattern related to CDC jitter J3. The executor 1321-3 executes simulation 1404. Thus, in simulation 1403, execution pattern P3=(J1, J2, J3)=(1, 0, 1).

The logic values of signals A, B, C at the ninth clock in simulation 1404 are respectively identical to the logic values of signals A, B, C at the ninth clock of simulation 1402. Therefore, the rest of simulation 1404 from the tenth clock is identical to simulation 1402 and thus, the controller 1307 forcibly terminates the child process 1320-3 and the executor 1301 executes the rest of simulation 1401 after the occurrence of CDC jitter J3.

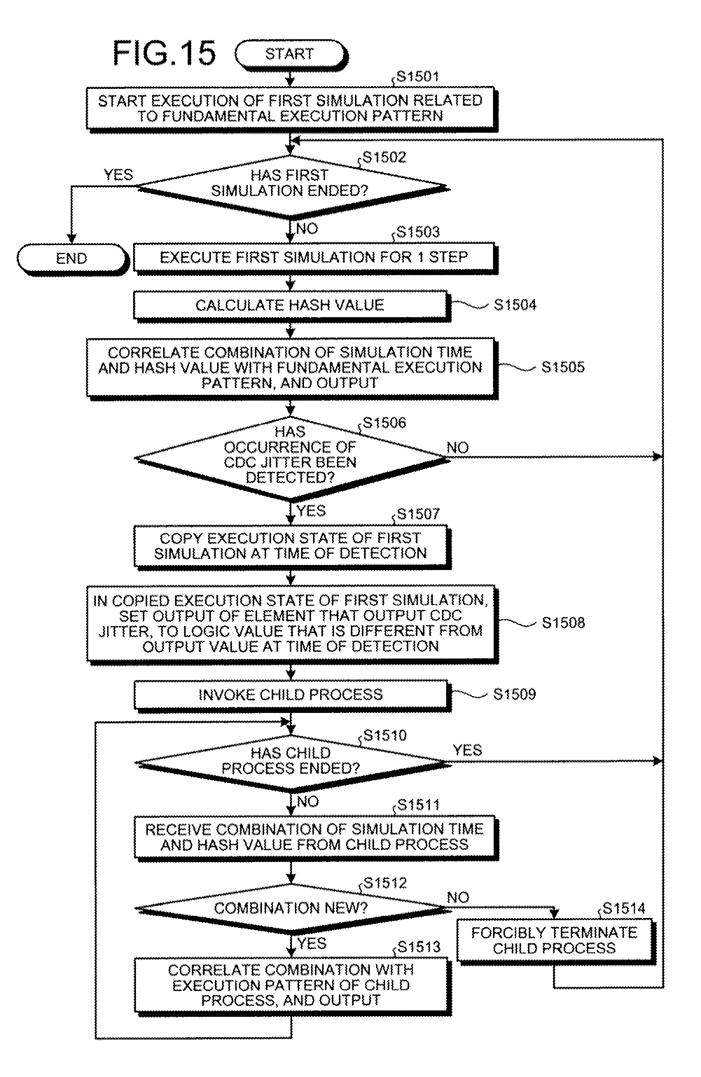

FIG. 15 is a flowchart depicting processing performed by the parent process 1300 of the verification support apparatus 700 according to the first embodiment. The parent process 1300, via the executor 1301, starts a first simulation (step S1501), and determines whether the first simulation has ended (step S1502). If the first simulation has not ended (step S1502: NO), the parent process 1300 executes the first simulation for 1 step (step S1503). Here, 1 step is a period defined by the simulation model 800 and is the unit of the execution time when simulation is performed. Although the 1 step is arbitrarily set by the verification engineer, for example, the 1 step is a period of time equivalent to 1 cycle of any clock, half a cycle, etc.

The parent process 1300 calculates a hash value related to a given element (step S1504), and correlates and outputs a fundamental execution pattern and a combination of the simulation time and the hash value (step S1505). The parent process 1300, via the detector 1302, determines whether the occurrence of CDC jitter has been detected (step S1506). If the occurrence of CDC jitter has not been detected (step S1506: NO), the parent process 1300 returns to step S1502.

If the occurrence of CDC jitter has been detected (step S1506: YES), the parent process 1300, via the copier 1311, copies the execution state of the first simulation at the time of detection (step S1507). The parent process 1300, via the setter 1312, sets in the copied execution state of the first simulation, the output of the element that output the detected CDC jitter, to a logic value that is different from the output value at the time of detection (step S1508). The parent process 1300, via the invoker 1313, invokes the child process 1320 based on the set execution state (step S1509).

The parent process 1300 determines whether the child process 1320 has ended (step S1510). If the child process 1320 has ended (step S1510: YES), the parent process 1300 returns to step S1502. If the child process 1320 has not ended (step S1510: NO), the parent process 1300, via the receiver 1305, receives the combination of the simulation time and the hash value related to the given element from the child process 1320 (step S1511).

The parent process 1300, via the determiner 1306, determines whether the received combination is new (step S1512). If the combination is new (step S1512: YES), the parent process 1300, via the output unit 1308, correlates and outputs the combination and the execution pattern of the child process 1320 (step S1513), and returns to step S1510.

If the combination is not new (step S1512: NO), the parent process 1300, via the controller 1307, forcibly terminates the child process 1320 (step S1514), and returns to step S1502.

At step S1502, if the parent process 1300 determines that the first simulation has ended (step S1502: YES), the parent process 1300 ends the processing.

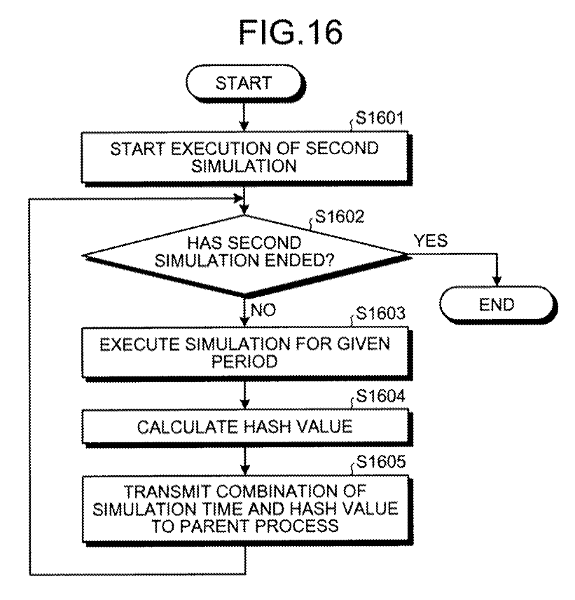

FIG. 16 is a flowchart depicting processing performed by the child process 1320-i of the verification support apparatus 700 according to the first embodiment. The child process 1320-i, via the executor 1321-i, starts execution of the second simulation (step S1601), and determines whether the second simulation has ended (step S1602).

If the second simulation has not ended (step S1602: NO), the child process 1320-i, via the executor 1321-i, executes the second simulation for the given period (step S1603). The child process 1320-i, via the calculator 1322-i, calculates a hash value related to a given element (step S1604). The child process 1320-i, via the transmitter 1323-i, transmits a combination of the simulation and the hash value to the parent process 1300 (step S1605), and returns to step S1602. At step S1602, if second simulation has ended (step S1602: YES), the child process 1320-i ends the processing.

According to the first embodiment, among simulations of different execution patterns, overlapping simulations are omitted, whereby the simulation time can be shortened.

In the second embodiment, even if a base execution pattern and an execution pattern that has a logic value of 1 CDC jitter that differs from the base execution pattern have the same state at the same simulation time, simulation is not terminated and is reused in the simulation of another execution pattern. Thus, the time consumed for the copying of the execution state and the time consumed for the setting of a logic value, combined with the time consumed for invoking simulation can be saved, enabling the simulation time to be shortened.

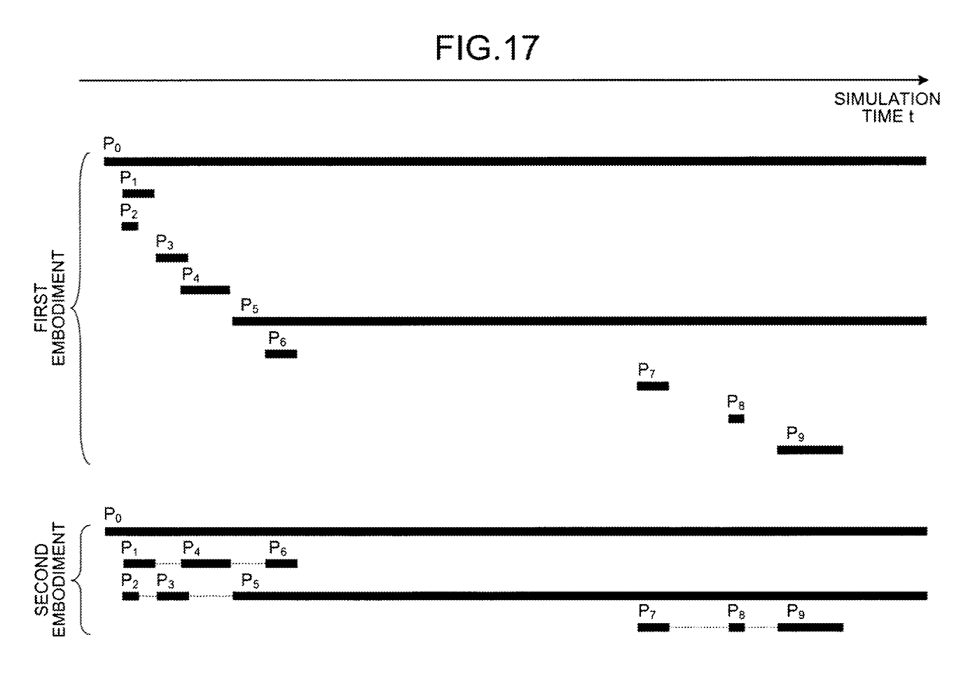

FIG. 17 is a diagram depicting an example of reducing the number of simulation invocations according to the second embodiment. In the second embodiment, even if the simulation of execution pattern P1 coincides with the simulation of base execution pattern P0, the simulation of execution pattern P1 is continued and reused as a simulation of execution pattern P4. In an example of the second embodiment, if the simulation of execution pattern P4 coincides with the simulation of base execution pattern P0, the simulation of execution pattern P4 is reused as a simulation of execution pattern P6.

Further, in the example of the second embodiment, even if the simulation of execution pattern P2 coincides with the simulation of base execution pattern P0, the simulation of execution pattern P2 is continued and reused as the simulation of execution pattern P3. If the simulation of execution pattern P3 coincides with the simulation of base execution pattern P0, the simulation of execution pattern P3 is reused as a simulation of execution pattern P5.

On the other hand, in the example of the first embodiment, if the simulations of execution patterns P1 to P9 coincide with the simulation of base execution pattern P0, the simulation of execution patterns P1 to P9 is ended.

For example, if the number of elements in the circuit under test is large, the time consumed for copying the execution state increases. As described, when the number of CDC jitters that occur is on the order of several hundred or several thousand, in the first embodiment, copy processing has to be performed several hundred or several thousand times, whereas in the second embodiment, the number of times that the copy processing is performed can be reduced compared to the first embodiment. Consequently, in the second embodiment, the simulation time can be shortened.

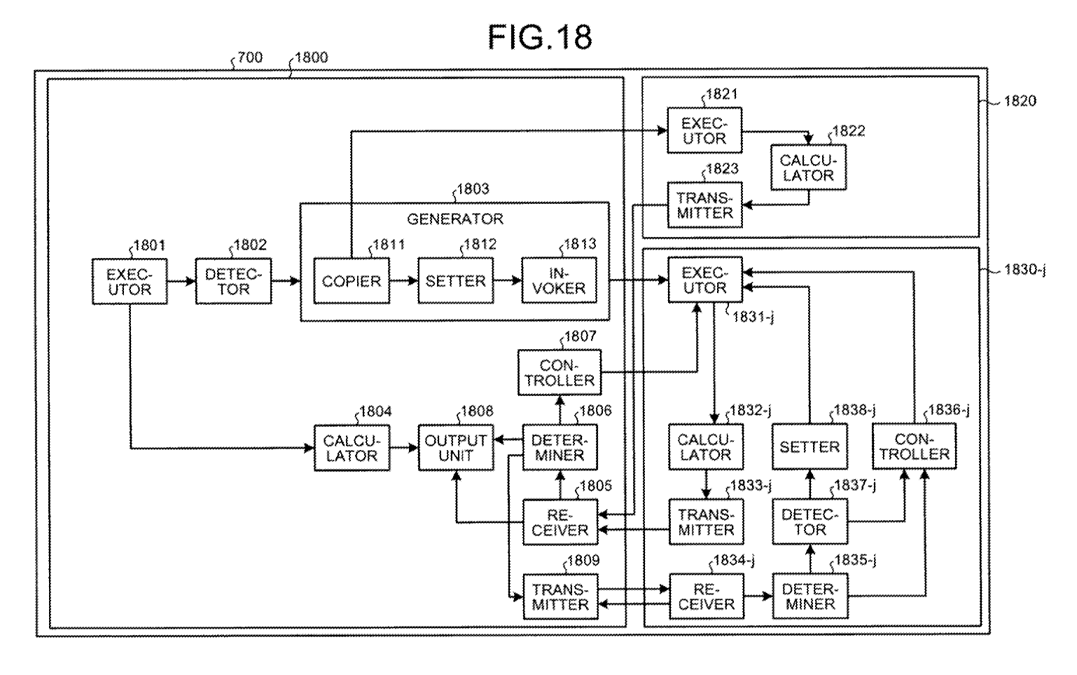

FIG. 18 is a block diagram depicting an example of a functional configuration of the verification support apparatus 700 according to the second embodiment. The verification support apparatus 700 has a parent process 1800, a child process 1820, and a child process 1830-j. The parent process 1800 executes a first simulation related to a fundamental execution pattern, and invokes the child process 1820 and the child process 1830-j. The child process 1820 executes a simulation related to the fundamental execution pattern. The child process 1830-j executes a second simulation related to an inverted execution pattern.

The parent process 1800 of the verification support apparatus 700 has an executor 1801, a detector 1802, a generator 1803, a calculator 1804, a receiver 1805, a determiner 1806, a controller 1807, an output unit 1808, and a transmitter 1809. The child process 1820 that is of the verification support apparatus 700 and executes a simulation related to the fundamental execution pattern has an executor 1821, a calculator 1822, and a transmitter 1823. The child process 1830-j that is of the verification support apparatus 700 and executes a simulation related to the inverted execution pattern has an executor 1831-j, a calculator 1832-j, a transmitter 1833-j, a receiver 1834-j, and a determiner 1835-j. The child process 1830-j further has a controller 1836-j, a detector 1837-j, and a setter 1838-j.

The processing of the executor 1801 to the transmitter 1809 of the parent process 1800, for example, is encoded by the simulation process controller 811 of the simulation model 800 above. The processing of the executor 1821 to the transmitter 1823 of the child process 1820 and the processing of the executor 1831-j and the setter 1838-j of the child process 1830-j, for example, is encoded by the simulation process controller 811 of the simulation model 800 above. The CPU 701 invokes the logic simulator and provides the simulation model 800 to the logic simulator, whereby the logic simulator processes the code described by the simulation process controller 811 of the simulation model 800 and thereby, implements the processing.

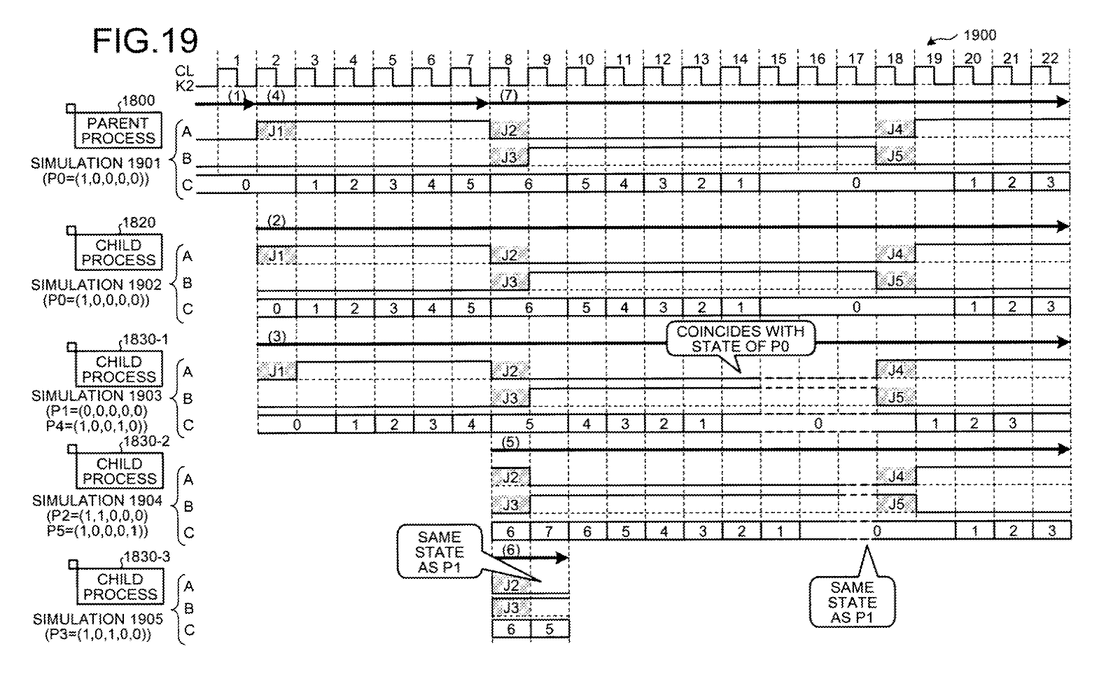

FIG. 19 is a diagram depicting an example of simulation according to the second embodiment. In timing chart 1900 in FIGS. 19, (1) to (7) are sequentially executed. In the example depicted in FIG. 19, the total CDC jitter count is 5 and i is 1 to 5. For example, the executor 1801 executes simulation 1901 related to fundamental execution pattern. For instance, in simulation 1901, it is assumed that the fundamental execution pattern is execution pattern P0=(J1, J2, J3, J4, J5)=(1, 0, 0, 0, 0). For execution pattern P0, random values may be generated by CDC jitter or the verification engineer may specify values in advance.

The executor 1801 executes simulation 1901. The detector 1802, during execution of simulation 1901, detects CDC jitter. CDC jitter detection processing is identical to the detection processing described in the first embodiment. The detector 1802 detects CDC jitter J1.

The generator 1803, upon CDC jitter J1 being detected by the detector 1802, determines whether the simulation related to the fundamental execution pattern has ended. If the executor 1803 that simulates the fundamental execution pattern has not completed execution, the generator 1803 generates the child process 1820 that executes simulation related to the fundamental execution pattern.

For example, the generator 1803 has a copier 1811 and an invoker 1813. The copier 1811 copies the execution state of simulation 1901 at the time of detection of CDC jitter J1. The invoker 1813 sets the copied execution state of simulation 1901 as the execution state of the child process 1820 and invokes the child process 1820. The executor 1821 of the child process executes simulation 1902.

For example, the calculator 1822, for each given period, calculates a hash value related to a given element and the transmitter 1823 transmits a combination of the simulation time and the hash value calculated by the calculator 1822, to the parent process 1800.

The receiver 1805, for example, receives the combination of the simulation time and the hash value from the child process 1820. The output unit 1808 correlates and outputs the combination, which is from the child process 1820 and received by the receiver 1805, with execution pattern P0. The form of output, for example, is storage to a storage device such as the RAM 703, the magnetic disk 705, and the optical disk 707.

When the child process 1820 completes execution, the generator 1803 generates child process 1830-1 that executes simulation 1803 related to execution pattern P1 that for the output value of the element that output the detected CDC jitter J1, has a logic value that is different from the detected logic value. For example, the generator 1803 has the copier 1811, a setter 1812, and the invoker 1813. The copier 1811 copies the execution state of simulation 1901 at the time of detection of CDC jitter J1.

The setter 1812 sets, in the copied execution state of simulation 1901, the output of the element that output the detected CDC jitter, to a logic value that is different from the logic value at the time of detection. The invoker 1813 specifies as the execution state of the child process 1830-1, the execution state set by the setter 1812 and invokes the child process 1830-1. Consequently, in simulation 1903, execution pattern P1=(J1, J2, J3, J4, J5)=(0, 0, 0, 0, 0).

The executor 1831-1 executes simulation 1903. The calculator 1832-1, for each given period, calculates a hash value related to a given element. The transmitter 1833-1 transmits a combination of the simulation and the hash value calculated by the calculator 1822 to the parent process 1800.

The receiver 1805 receives the combination from the child process 1830-1. The determiner 1806 determines whether the combination received by the receiver 1805 is among combinations correlated to the fundamental execution pattern that has already been simulated. For example, if the simulation time of the combination transmitted from the child process 1830-1 is a simulation time indicating the fourteenth clock, the state of execution pattern P1 and the state of execution pattern PO coincide. Consequently, the determiner 1806 determines that the same combination is present. The transmitter 1809 transmits the determination result to the child process 1830-1.

For example, the receiver 1834-1 receives the determination result from the parent process 1800. The determiner 1835-1 determines whether the determination result indicates that the combination received from child process 1830-1 is a combination correlated with the fundamental execution pattern.

For example, if the determination result of the determiner 1835-1 is that the combination is a combination correlated with the fundamental execution pattern, the detector 1837-1 continues simulation 1903 and detects a new CDC jitter.

If the detector 1837-1 does not detect a new CDC jitter within a given period of time, the controller 1836-1 terminates the execution of simulation 1903. For example, after determination by the determiner 1835-1, the controller 1836-1 sets a timeout time and if the detector 1837-1 does not detect a new CDC jitter before the timeout time, the controller 1836-1 controls the executor 1831-1 to terminate simulation 1903.

Here, the period from the simulation time at the time of determination by the determiner 1835-1 until the timeout time is, for example, on the order of the time consumed to copy the memory. Consequently, if CDC jitter is not detected over a period longer than that to copy the memory, the resumption of simulation 1901 of the parent process 1800 would shorten the total time of the simulations. The time consumed for copying the memory is dependent upon the size of the circuit under test and the input pattern and therefore, is not a fixed value. Consequently, the verification engineer may determine the timeout time.

In the example in FIG. 19, the detector 1837-1 detects CDC jitter J4 at the eighteenth clock. The detector 1837-1 determines whether simulation related to an inverted execution pattern in which the logic value of the detected CDC jitter J4 is inverted has been executed. In the example in FIG. 19, simulation related to the inverted execution pattern has not been executed. Hence, the setter 1838-1 sets the output of the element that output CDC jitter J4 in the execution state of simulation 1903, to a logic value that is different from the logic value detected by the detector 1837-1. The executor 1831-1, based on the execution state set by the setter 1838-1, executes simulation 1903. Thus, in simulation 1903, execution pattern P4=(J1, J2, J3, J4, J5)=(1, 0, 0, 1, 0).

In FIG. 19, child process 1830-2 executes simulation 1904 related to execution pattern P2=(J1, J2, J3, J4, J5)=(1, 1, 0, 0, 0) and to execution pattern P5=(J1, J2, J3, J4, J5)=(1, 0, 0, 0, 1).

In the example depicted in FIG. 19, the child process 1830-3 executes simulation 1905 related to execution pattern P3. For example, the determiner 1835-3 determines whether the determination result received by the receiver 1834-3 indicates that the combination transmitted by the transmitter 1833-3 is the combination of another execution pattern that is not the fundamental execution pattern. If the determiner 1835-3 determines that the determination result indicates that the combination is the combination of another execution pattern that is not the fundamental execution pattern, the controller 1836-3 controls the executor 1831-3 to terminate simulation 1905.

If the simulation under execution and the executed simulation related to another execution pattern that is not the fundamental execution pattern are the same simulation, the rest of the simulation under execution is also the same. Therefore, the potential that CDC jitter detected in the executed simulation will occur in the rest of the simulation is high and consequently, the simulation under execution is terminated, enabling the simulation time to be shortened.

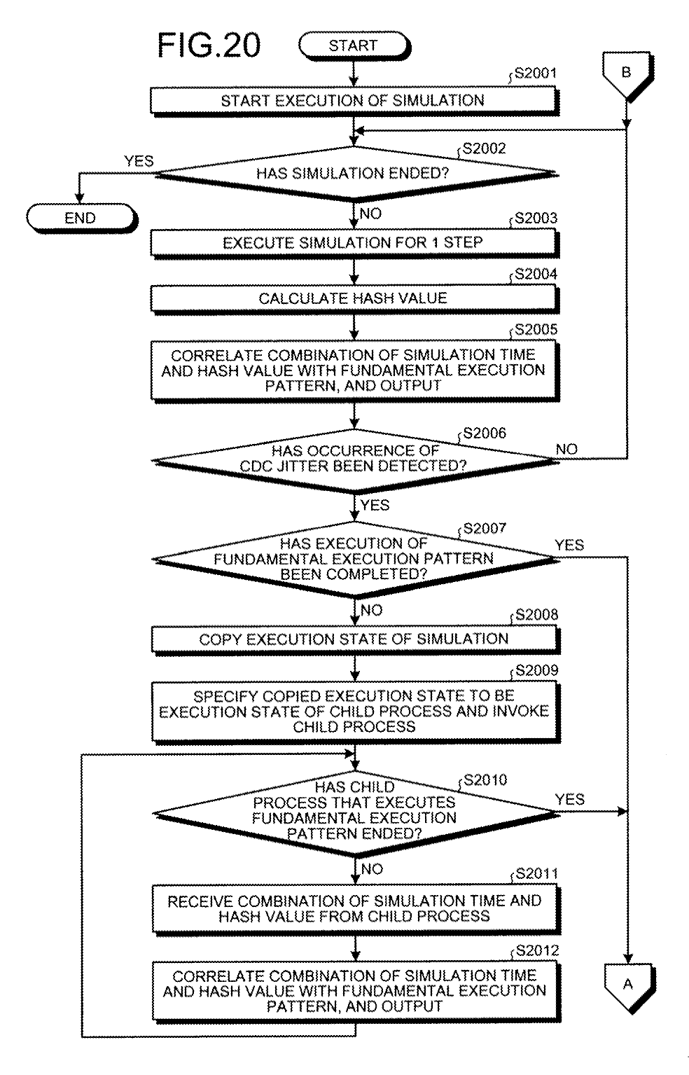

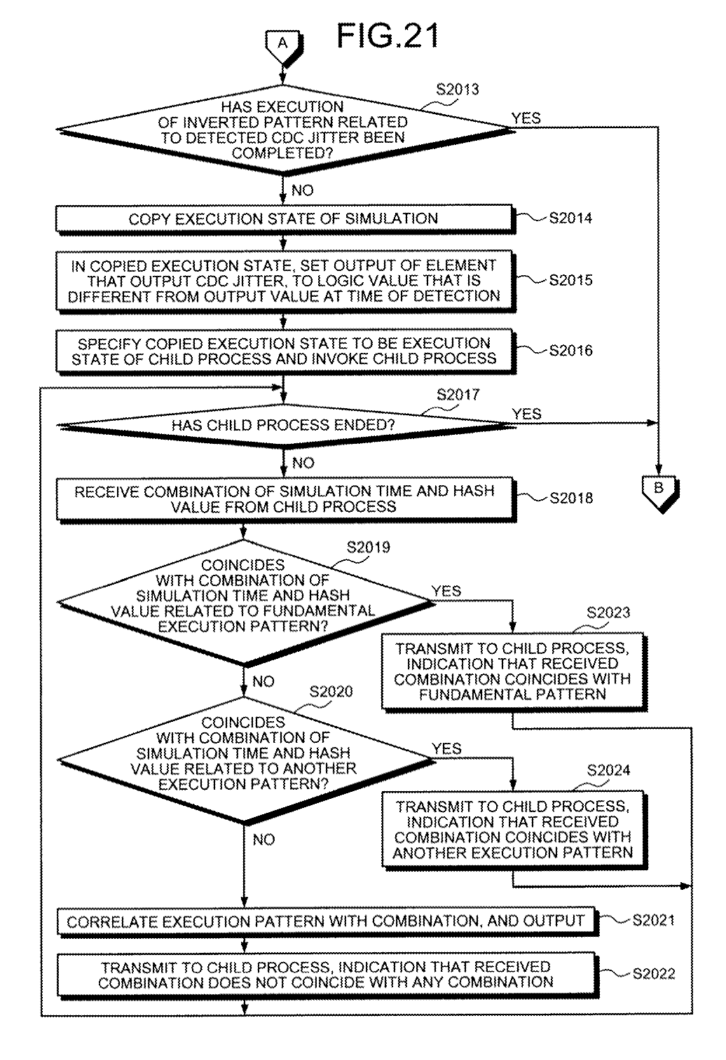

FIG. 20 and FIG. 21 are flowcharts depicting processing performed by the parent process 1800 of the verification support apparatus 700 according to the second embodiment. The parent process 1800 starts a simulation (step S2001), and determines whether the simulation has ended (step S2002). If the simulation has not ended (step S2002: NO), the parent process 1800 executes the simulation for 1 step (step S2003).

The parent process 1800 calculates a hash value (step S2004), and correlates a combination of the simulation time and the hash value with the fundamental execution pattern (step S2005). The parent process 1800 determines whether the occurrence of CDC jitter has been detected (step S2006). If the occurrence of CDC jitter has not been detected (step S2006: NO), the parent process 1800 returns to step S2002.

If the occurrence of CDC jitter has been detected (step S2006: YES), the parent process 1800 determines whether execution of the fundamental execution pattern has ended (step S2007). If execution has not ended (step S2007: NO), the parent process 1800 copies the execution state of the simulation (step S2008). The parent process 1800 specifies the copied simulation to be the execution state of the child process 1820 and invokes the child process 1820 (step S2009).

The parent process 1800 determines whether the child process 1820 that executes the fundamental execution pattern has ended (step S2010). If the child process 1820 has not ended (step S2010: NO), the parent process 1800 receives a combination of the simulation time and a hash value, from the child process 1820 that executes the fundamental execution pattern (step S2011). The parent process 1800 correlates and outputs the combination of the simulation time and the hash value with the fundamental execution pattern (step S2012), and returns to step S2010.

At step S2007, if execution of the fundamental execution pattern has ended (step S2007: YES), the parent process 1800 transitions to step S2013. At step S2010, if the child process 1820 that executes the fundamental execution pattern has ended (step S2010: YES), the parent process 1800 transitions to step S2013.

The parent process 1800 determines whether execution of an inverted pattern related to the detected CDC jitter has been completed (step S2013). If execution of the inverted pattern has not been completed (step S2013: NO), the parent process 1800 copies the execution state of the simulation (step S2014).

The parent process 1800 sets, in the copied execution state, the output value of the element that output the CDC jitter, to a logic value that is different from the output value at the time of detection (step S2015). The parent process 1800 specifies the copied execution state of the simulation to be the execution state of the child process 1830-j and invokes the child process 1830-j (step S2016).

The parent process 1800 determines whether the child process 1830-j has ended (step S2017). If the child process 1830-j has not ended (step S2017: NO), the parent process 1800 receives a combination of the simulation time and a hash value from the child process 1830-j (step S2018). The parent process 1800 determines whether the received combination coincides with a combination of a simulation time and a hash value related to the fundamental execution pattern (step S2019).

If the combination does not coincide with a combination related to the fundamental execution pattern (step S2019: NO), the parent process 1800 transitions to step S2020. The parent process 1800 determines whether the received combination coincides with a combination of a simulation time and hash value related to another execution pattern (step S2020). If the received combination does not coincide with a combination related another execution pattern (step S2020: NO), the parent process 1800 correlates and outputs the execution pattern with the received combination of a simulation time and hash value (step S2021). The parent process 1800 transmits to the child process 1830-j, indication that the received combination does not coincide with any combinations (step S2022), and transitions to step S2017.

At step S2019, if the received combination coincides with a combination of a simulation time and hash value related to the fundamental execution pattern (step S2019: YES), the parent process 1800 transitions to step S2023. The parent process 1800 transmits to the child process, indication that the received combination coincides with that of the fundamental execution pattern (step S2023), and returns to step S2017. At step S2020, if the received combination coincides with that related to another execution pattern (step S2020: YES), the parent process 1800 transmits to the child process 1830-j, indication that the received combination coincides with that of another execution pattern (step S2024), and returns to step S2017.

At step S2013, if execution of the inverted pattern related to the detected CDC jitter has been completed (step S2013: YES), the parent process 1800 returns to step S2002.

At step S2017, if the child process 1830-j has ended (step S2017: YES), the parent process 1800 returns to step S2002. At step S2002, if the simulation has ended (step S2002: YES), the parent process 1800 ends the processing.

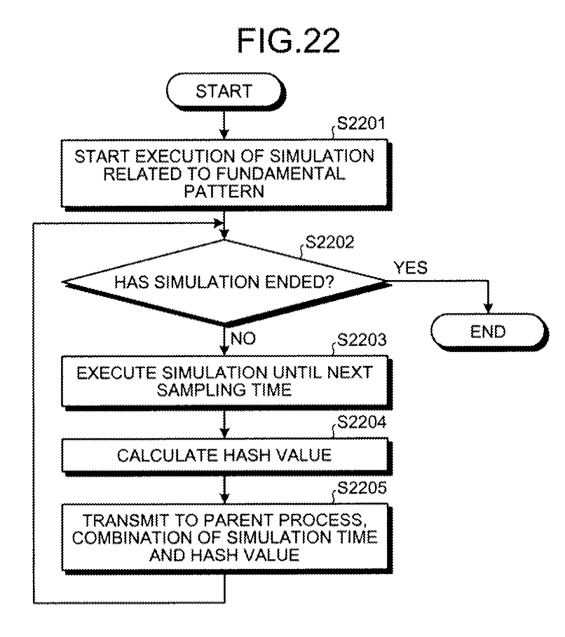

FIG. 22 is a flowchart depicting the processing performed by the child process 1820 that is of the verification support apparatus 700 according to the second embodiment and executes the fundamental execution pattern. The child process 1820, which executes the fundamental execution pattern, starts simulation based on an execution state that has been set (step S2201), and determines whether the simulation has ended (step S2202).

If simulation has not ended (step S2202: NO) the child process 1820 executes the simulation until the next sampling time (step S2203). The child process 1820 calculates a hash value (step S2204), transmits a combination of the simulation time and the hash value to the parent process 1800 (step S2205), and returns to step S2202.

At step S2202, if the simulation has ended (step S2202: YES), the child process 1820 ends the processing.

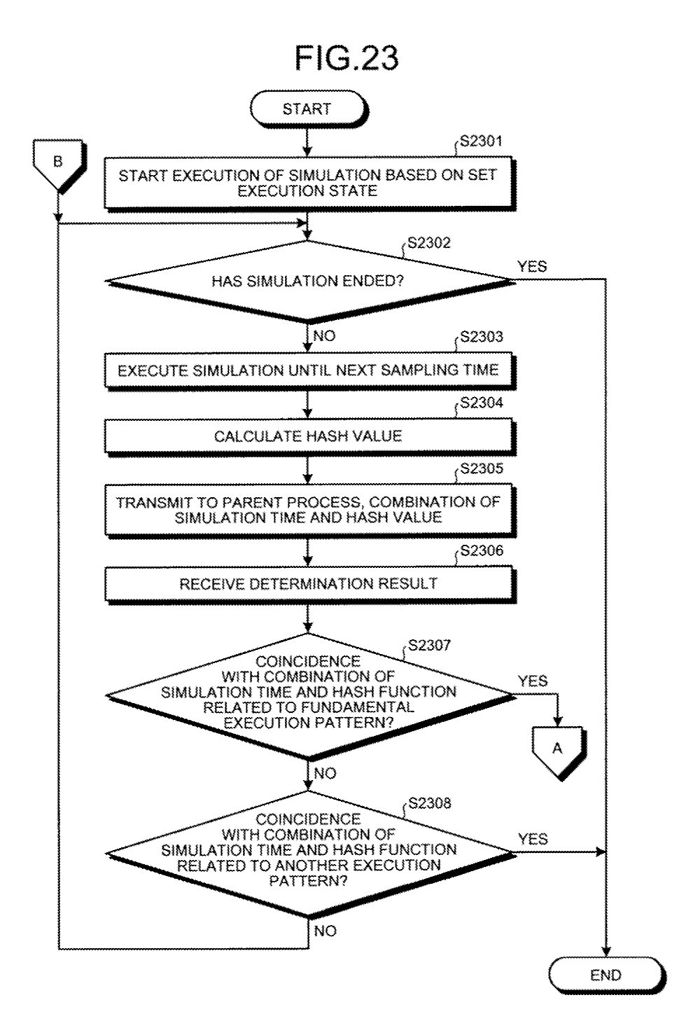

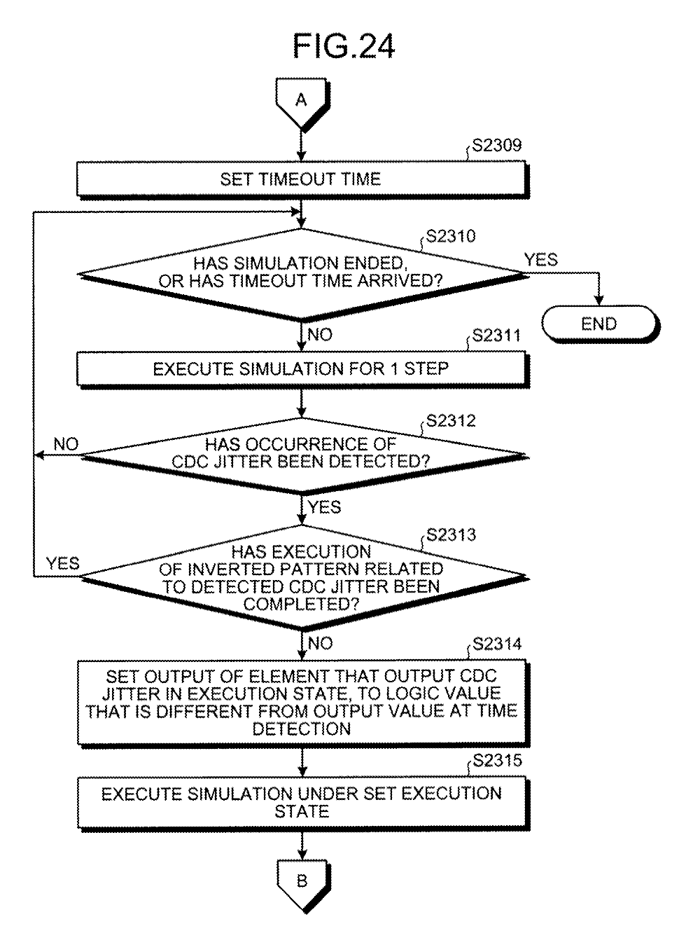

FIG. 23 and FIG. 24 are flowcharts depicting processing performed by the child process 1830-j that is of the verification support apparatus 700 according to the second embodiment and executes the inverted pattern. The child process 1830-j starts simulation based on an execution state that has been set (step S2301). The child process 1830-j determines whether the simulation has ended (step S2302).

If the simulation has not ended (step S2302: NO), the child process 1830-j executes the simulation until the next sampling time (step S2303). The child process 1830-j calculates a hash value (step S2304), and outputs a combination of the simulation time and the hash value to the parent process (step S2305).

The child process 1830-j receives a determination result (step S2306), and determines whether the determination result indicates coincidence with a combination of a simulation time and hash function related to the fundamental execution pattern (step S2307). If the determination result does not indicate coincidence (step S2307: NO), the child process 1830-j transitions to step S2308, and determines whether the determination result indicates coincidence with a combination of a simulation time and hash value related to another execution pattern (step S2308).

If the determination result does not indicate coincidence with a combination related to another execution pattern (step S2308: NO), the child process 1830-j returns to step S2302. If the determination result indicates coincidence with a combination related to another execution pattern (step S2308: YES), the child process 1830-j ends the processing.

If the determination result indicates coincidence with the combination related to the fundamental execution pattern (step S2307: YES), the child process 1830-j sets a timeout time (step S2309). The child process 1830-j determines if the simulation has ended or if the timeout time has arrive (step S2310).

If the simulation has not ended and the timeout time has not arrived (step S2310: NO), the child process 1830-j executes the simulation for 1 step (step S2311). The child process 1830-j determines whether the occurrence of CDC jitter has been detected (step S2312).

If the occurrence of CDC jitter has not been detected (step S2312: NO), the child process 1830-j returns to step S2310. If the occurrence of CDC jitter has been detected (step S2312: YES), the child process 1830-j determines whether execution of an inverted pattern related to the detected CDC jitter has been completed (step S2313). If execution of the inverted pattern has been completed (step S2313: YES), the child process 1830-j returns to step S2310.

If execution of the inverted pattern has not been completed (step S2313: NO), the child process 1830-j sets the output value of the element that output the detected CDC jitter in the execution state, to a logic value that is different from the output value at the time of detection (step S2314). The child process 1830-j executes a simulation under the set execution state (step S2315), and returns to step S2302.

At step S2302, if the simulation has ended (step S2302: YES), the child process 1830-j ends the processing. If the simulation has ended or if the timeout time has arrived (step S2310: YES), the child process 1830-j ends the processing.

According to the second embodiment, even if the state of a simulation related to the fundamental execution pattern and the state of a simulation under execution coincide at the same simulation time, the execution of the simulation is continued and is used as a simulation related to another execution pattern. Thus, the time consumed for invoking a simulation can be shortened as well as the simulation time.

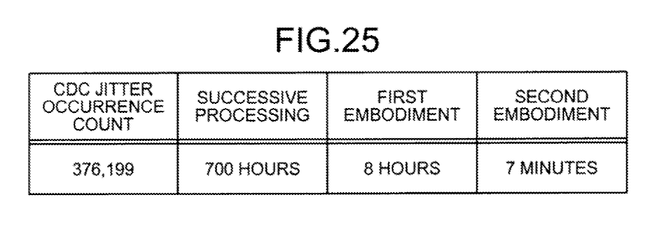

FIG. 25 is a diagram depicting an example of the time required for simulation. FIG. 25 depicts the time required to obtain all simulation results for a base execution pattern such as that depicted in FIG. 6, where a given input pattern is applied to circuit information of a given circuit under test and the logic value of each CDC jitter is sequentially changed. In the example depicted in FIG. 25, for a CDC jitter occurrence count of 376199, simulation by conventional successive processing requires 700 hours, simulation by the verification support processing according to the first embodiment requires 8 hours, and simulation by the verification support processing according to the second embodiment requires 7 minutes. Although dependent on the circuit under test and the input pattern, the first embodiment and the second embodiment enable the simulation time to be shortened.

As described, according to the first embodiment, the verification support apparatus detects CDC jitter during the execution of a first simulation and exclusive of the first simulation, executes a second simulation in which the logic value is different from the logic value of the CDC jitter at the time of detection. Thus, simulation overlapping between the first and the second simulations until the occurrence of CDC jitter is omitted, enabling a shortening of the simulation time. Further, the addition of the verification support apparatus functions to the simulation model enables favorable simulation to be performed using a general logic simulator.

If CDC jitter is newly detected during execution of the first simulation after execution of the second simulation has been completed, the verification support apparatus executes, exclusive of the first simulation, a third simulation where the logic value is different from that of the CDC jitter at the time of detection. During execution of the third simulation, if the state of a given element coincides with the state at the same simulation time in the second simulation, the verification support apparatus ends the third simulation. Thus, overlapping execution of the second simulation and the third simulation can be omitted, enabling the simulation time to be shortened.

According to the second embodiment, even if the state of a given element is the same at the same time (clock) in the completed first simulation and in the second simulation under execution, the verification support apparatus does not terminate the second simulation, but rather reuses the second simulation for another execution pattern. Thus, the time consumed for copying the execution state, the time consumed for logic value setting, and the time consumed for invoking simulation can be saved, enabling the simulation time to be shortened. The addition of the functions of the verification support apparatus to a simulation model, enables simulation using a general logic simulator.

Even if the given period or longer elapses and CDC jitter is not detected, the second simulation is terminated, whereby execution of first simulation can be resumed and the simulation time can be shortened.

The verification support method described in the present embodiment may be implemented by executing a prepared program on a computer such as a personal computer and a workstation. The program is stored on a computer-readable medium such as a hard disk, a flexible disk, a CD-ROM, an MO, and a DVD, read out from the recording medium, and executed by the computer. The program may be distributed through a network such as the Internet. However, the computer-readable medium does not include a transitory medium such as a propagation signal.

A computer-readable medium stores therein a verification support program that causes a computer to execute a process. The computer has access to a storage device storing therein a simulation result that for each simulation time of a first simulation, includes the state of a given element included in circuit information for a circuit under test having a first clock domain and a second clock domain that receives asynchronously a signal from the first clock domain; the first simulation being of a given input pattern applied to the circuit information. The process executed by the computer includes executing the first simulation; detecting during the execution of the first simulation, an output value that is a random value output by an element in the second clock domain that receives the signal; copying the execution state of the first simulation at the time of detection of the output value that is a random value; setting in the copied execution state of the first simulation, output of the element in the second clock domain, to a logic value that is different from the detected output value; executing exclusive of the first simulation, a second simulation that is based on the set execution state; determining during execution of the second simulation, whether for the same time in the second simulation, the state of the given element coincides with the simulation result stored in the storage device; detecting during the second simulation, an output value that is a random value output by an element in the second clock domain, when the state of the given element and the simulation result for the same time are determined to coincide; setting in the execution state of the second simulation, output of an element in the second clock domain, to a logic value that is different from the detected output value; and executing the second simulation based on the set execution state.

The process further includes terminating the second simulation, when for the same time in the second simulation, the state of the given element coincides with the simulation result stored in the storage device.

A verification support method is executed by a computer having access to a storage device storing therein a simulation result that for each simulation time of a first simulation, includes the state of a given element included in circuit information for a circuit under test having a first clock domain and a second clock domain that receives asynchronously a signal from the first clock domain. The first simulation is of a given input pattern applied to the circuit information. The verification support method includes executing the first simulation; detecting during execution of the first simulation, an output value that is a random value output by an element in the second clock domain that receives the signal; copying the execution state of the first simulation at the time of detection of the output value that is a random value; setting in the copied execution state of the first simulation, output of the element in the second clock domain, to a logic value that is different from the detected output value; executing exclusive of the first simulation, a second simulation that is based on the set execution state; determining during execution of the second simulation, whether for the same time in the second simulation, the state of the given element coincides with the simulation result stored in the storage device; detecting during the second simulation, an output value that is a random value output by an element in the second clock domain, when the state of the given element and the simulation result for the same time are determined to coincide; setting in the execution state of the second simulation, output of an element in the second clock domain, to a logic value that is different from the detected output value; and executing the second simulation based on the set execution state.

A verification support apparatus has access to a storage device storing therein a simulation result that for each simulation time of a first simulation, includes the state of a given element included in circuit information for a circuit under test having a first clock domain and a second clock domain that receives asynchronously a signal from the first clock domain. The first simulation is of a given input pattern applied to the circuit information. The verification support apparatus includes a first executor that executes the first simulation; a first detector that detects during execution of the first simulation, an output value that is a random value output by an element in the second clock domain that receives the signal; a copier that copies the execution state of the first simulation at the time of detection of the output value that is a random value; a first setter that in the copied execution state of the first simulation, sets output of the element in the second clock domain, to a logic value that is different from the detected output value; a second executor that executes exclusive of the first simulation, a second simulation that is based on the execution state set by the first setter; a determiner that during execution of the second simulation by the second executor, whether for the same time in the second simulation, the state of the given element coincides with the simulation result stored in the storage device; a second detector that during the second simulation, detects an output value that is a random value output by an element in the second clock domain, when the state of the given element and the simulation result for the same time are determined by the determiner to coincide; a second setter that in the execution state of the second simulation, sets output of an element in the second clock domain, to a logic value that is different from the output value detected by the second detector. The second executor executes the second simulation based on the execution state set by the second setter.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable medium storing therein a verification support program that causes a computer to execute a process, the process comprising:
executing a first simulation of applying a given input pattern to circuit information of a circuit under test having a first clock domain and a second clock domain that receives asynchronously a signal from the first clock domain;
detecting during execution of the first simulation, an output value that is a random value output by an element in the second clock domain that receives the signal;
copying the execution state of the first simulation at the time of detection of the output value that is a random value;
setting in the copied execution state of the first simulation, output of the element in the second clock domain, to a logic value that is different from the detected output value; and
executing, exclusive of the first simulation, a second simulation that is based on the set execution state.

2. The computer-readable medium according to claim 1, the process further comprising:
detecting during execution of the first simulation after execution of the second simulation, an output value that is a random value output by an element in the second clock domain that receives the signal;
copying the execution state of the first simulation at the time of detection of the output value that is a random value;
setting in the copied execution state of the first simulation, output of the element in the second clock domain, to a logic value that is different from the detected output value;
executing, exclusive of the first simulation, a third simulation that is based on the set execution state;
determining whether the state of a given element in the circuit information coincides with a state at the same time in the second simulation and the third simulation;
terminating the third simulation, when the state of the given element is determined to coincide with a state at the same time in the second simulation and the third simulation.

3. A verification support method executed by a computer, the verification support method comprising:
executing a first simulation of applying a given input pattern to circuit information of a circuit under test having a first clock domain and a second clock domain that receives asynchronously a signal from the first clock domain;
detecting during execution of the first simulation, an output value that is a random value output by an element in the second clock domain that receives the signal;
copying the execution state of the first simulation at the time of detection of the output value that is a random value;
setting in the copied execution state of the first simulation, output of the element in the second clock domain, to a logic value that is different from the detected output value; and
executing, exclusive of the first simulation, a second simulation that is based on the set execution state.

4. A verification support apparatus comprising:
a first executor that executes a first simulation of applying a given input pattern to circuit information of a circuit under test having a first clock domain and a second clock domain that receives asynchronously a signal from the first clock domain;
a detector that during execution of the first simulation by the first executor, detects an output value that is a random value output by an element in the second clock domain that receives the signal;
a copier that copies the execution state of the first simulation at the time of detection of the output value that is a random value;
a setter that in the execution state copied by the copier, sets output of the element in the second clock domain, to a logic value that is different from the detected output value; and
a second executor that exclusive of the first simulation, executes a second simulation that is based on the execution state set by the setter.
